(19) United States
(12) Patent Application Publication
(10) Pub. No.: US 2012/0020006 A1
(43) Pub. Date: Jan. 26, 2012

(54) SERVER

(75) Inventors: Ji-Peng Xu, Shanghai City (CN); Tsai-Kuei Cheng, Taipei City (TW)

(73) Assignee: INVENTEC CORPORATION, Taipei City (TW)

(21) Appl. No.: 12/887,103

(22) Filed: Sep. 21, 2010

(30) Foreign Application Priority Data
Jul. 21, 2010 (CN) 201010236066.2

(51) Int. Cl. G06F 1/16

(52) U.S. Cl. 361/679.33; 361/679.4

(57) ABSTRACT

A server includes a rack, a slide rail, an input/output (I/O) dock, and a chassis. The rack has a front end and a rear end. The slide rail is disposed in the rack. The I/O dock is located at the rear end of the rack and fixed to an end of the slide rail. The chassis is slidably disposed on the slide rail. Here, the chassis moves relatively to the rack along the slide rail to come into contact with the I/O dock or to be away from the I/O dock.

### CROSS-REFERENCE TO RELATED APPLICATION

This application claims the priority benefit of China application serial no. 201010236066.2, filed on Jul. 21, 2010. The entirety of the above-mentioned patent application is hereby incorporated by reference herein and made a part of specification.

### BACKGROUND OF THE INVENTION

1. Field of the Invention

The invention relates to a server, and more particularly, to a rack mountable server.

2. Description of Related Art

A server is the core which serves all the computers in a network system and can provide necessary discs, printing services, and so forth. In addition, the server allows users to share the resources in the network. The basic framework of the server is approximately the same as that of an ordinary personal computer and comprises a central processing unit (CPU), a memory, and input/output (I/O) equipment, which are connected by a bus inside. Through north bridge chips, the CPU and the memory are connected, and through south bridge chips, the I/O dock is connected. The development of the server may be roughly divided into three phases based on the structure of a chassis: a tower chassis, a rack mountable chassis characterized by concentration properties, and a blade server featuring high-density calculation.

The rack mountable server is given as an example here. The rack mountable server has appearance of standard design and is used together with a cabinet. In other words, the rack mountable server is a tower server having improved structure to reduce the space occupied in the server as much as possible. Many specialized network equipment has the rack mountable structure, which is mostly in a flat type (like drawers). The aforesaid network equipment is, for example, an exchanger, a router, a hardware firewall, and so on. The rack mountable server is 19 inches wide, and the height thereof is measured by the unit U (1U=1.75 inches=44.45 millimeters). Generally speaking, the server has 1U, 2U, 3U, 4U, 5U, and 7U types.

The size of the cabinet is also regulated by industrial standards, generally from 22U to 42U. Detachable sliding trays are disposed in the cabinet based on the height (U). The user can flexibly adjust the height according to the height dimension of the server in order to store network equipment, such as servers, hubs, disc array cabinets, and the like. After the server is well placed in the chassis, the cables of the server are all led out from the rear of the cabinet and organized in the cable trenches of the cabinet. Numeral labels are commonly used to mark the cables for easy management.

The I/O dock of the rack mountable server is normally fixed onto the chassis, and the chassis is slidably disposed on the sliding trays. During necessary maintenance or repair of the components in the chassis, the cables connected to the I/O dock need to be removed and the chassis, together with the I/O dock, can then be pulled out from the cabinet for maintenance or repair, which is rather time-consuming and inconvenient. In addition, dense distribution of the cables leads to difficulty in removing the cables because of the limited space at the rear of the server.

### SUMMARY OF THE INVENTION

The invention is directed to a server apt to be maintained and repaired.

The invention provides a server including a rack, a slide rail, an input/output (I/O) dock, and a chassis. The rack has a front end and a rear end. The slide rail is disposed in the rack. The I/O dock is located at the rear end of the rack and fixed to an end of the slide rail. The chassis is slidably disposed on the slide rail. Here, the chassis moves relatively to the rack along the slide rail to come into contact with the I/O dock or to be away from the I/O dock.

According to an embodiment of the invention, the I/O dock has an opening, and a first connector is disposed at a rear end of the chassis. The server further includes a circuit board, a hard disc array, and a motherboard module array. The circuit board is disposed on the I/O dock. Here, a second connector is disposed on one surface of the circuit board facing the chassis, the opening exposes the second connector, a plurality of I/O ports are fixed on the other surface of the circuit board back towards the chassis, and the I/O ports are electrically connected to the second connector. The hard disc array is disposed in the chassis and electrically connected to the first connector. The motherboard module array is disposed in the chassis and electrically connected to the first connector. When the chassis comes into contact with the I/O dock, the first connector connects the second connector, so as to electrically connect the hard disc array and the motherboard module array to the I/O ports.

According to an embodiment of the invention, the server further includes a cushion element disposed on a surface of the I/O dock facing the chassis.

According to an embodiment of the invention, a material of the cushion element is rubber.

According to an embodiment of the invention, there is at least one handle distance between an end of the chassis and the I/O dock.

According to an embodiment of the invention, the front end and the rear end of the rack are opposite to each other, the I/O dock is located at the rear end of the rack, and the chassis is suitable for being pulled out from the front end of the rack.

According to an embodiment of the invention, the chassis has two side walls. Each of the side walls has at least one ventilator, and heat dissipation air flow is suitable for flowing from one of the side walls to the other one of the side walls through the ventilators.

Based on the above, the I/O dock of the invention is fixed to one end of the slide rail, and the chassis is suitable for moving along the slide rail, such that the chassis comes into contact with the I/O dock or is away from the I/O dock. Accordingly, during necessary maintenance or repair of the hard disc array or the motherboard module array in the chassis, the cables connected to the I/O dock need not to be removed, and the chassis can be directly pulled out from the rack, which facilitates maintenance and repair of the server.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a three-dimensional view illustrating a server according to an embodiment of the invention.

FIG. 1B is a three-dimensional view showing that a server depicted in FIG. 1A is being pulled out from a rack.

FIG. 2 is a top view illustrating the server depicted in FIG. 1A.

FIG. 3 is a three-dimensional view illustrating some components in the server depicted in FIG. 1A.

FIG. 4 is an exploded view illustrating some components in the server depicted in FIG. 1A.

### DESCRIPTION OF EMBODIMENTS

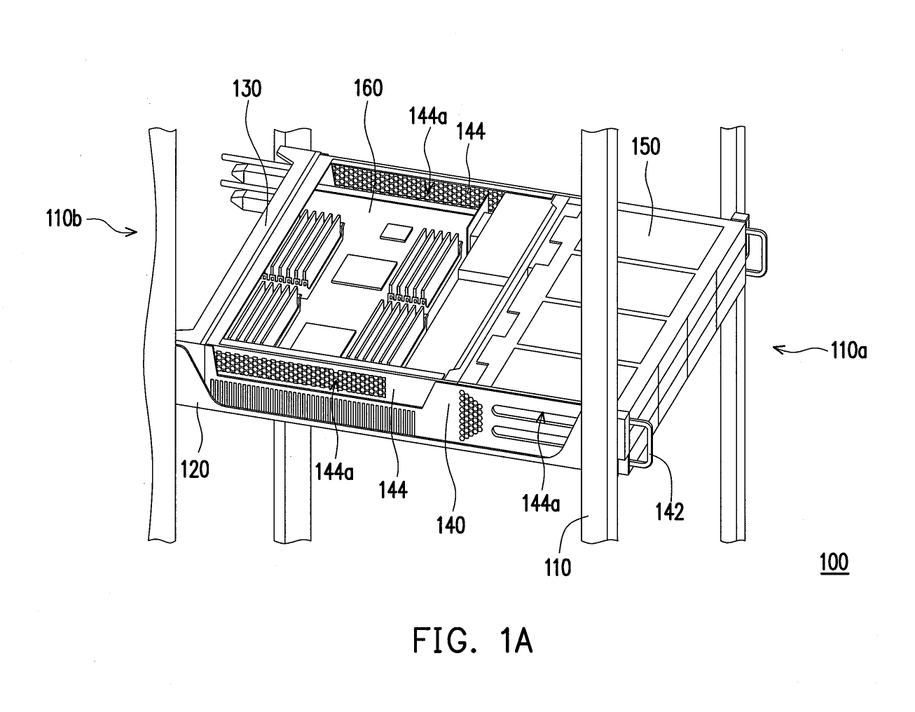

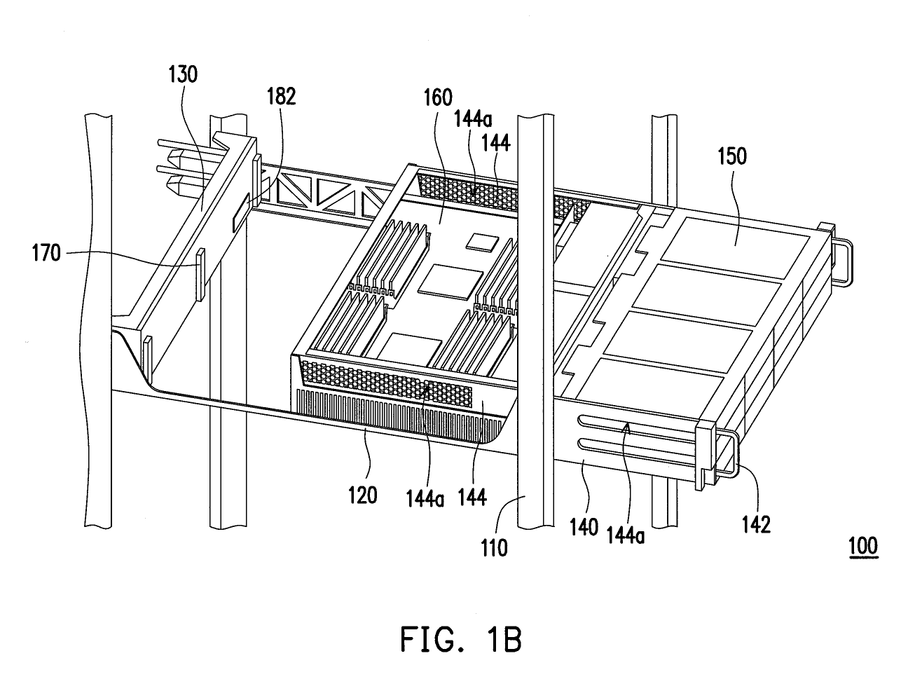

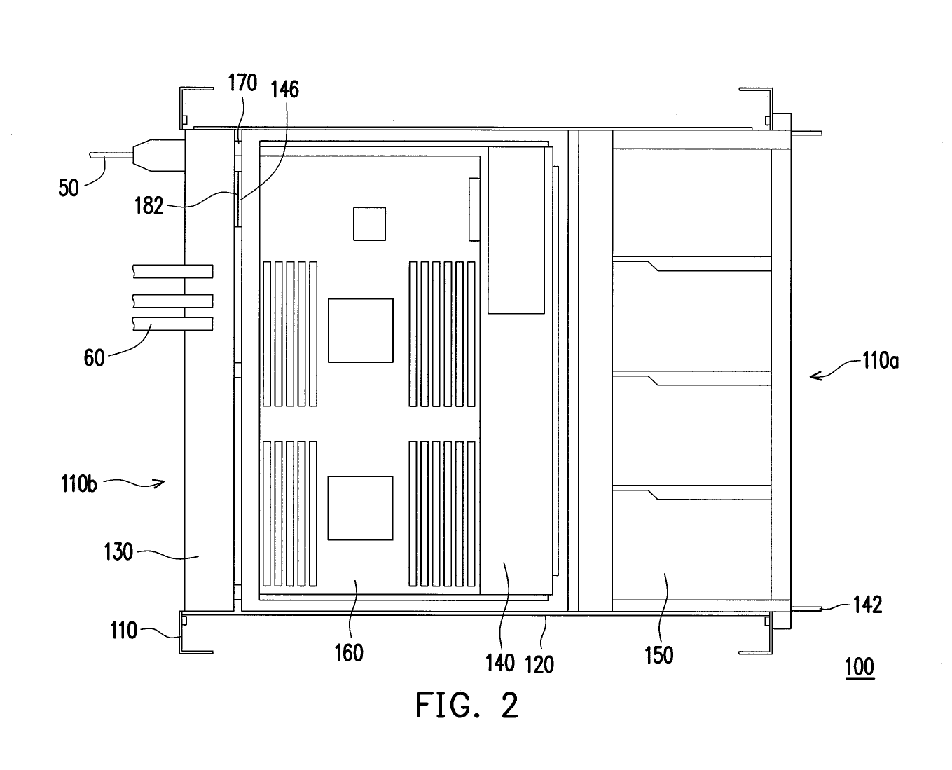

FIG. 1A is a three-dimensional view illustrating a server according to an embodiment of the invention. FIG. 1B is a three-dimensional view showing that a server depicted in FIG. 1A is being pulled out from a rack. FIG. 2 is a top view illustrating the server depicted in FIG. 1A. With reference to FIG. 1A, FIG. 1B, and FIG. 2, a server 100 of this embodiment includes a rack 110, a slide rail 120, an I/O dock 130, a chassis 140, a hard disc array 150, and a motherboard module array 160. The rack 110 has a front end 110a and a rear end 110b. The slide rail 120 is disposed in the rack 110. The I/O dock 130 is located at the rear end 110b of the rack 110 and fixed to an end of the slide rail 120. The chassis 140 is suitable for being pulled out from the front end 110a of the rack 110.

The chassis 140 is slidably disposed on the slide rail 120 and suitable for moving relatively to the rack 110 along the slide rail 120, such that the chassis 140 comes into contact with the I/O dock 130 (as shown in FIG. 1A and FIG. 2) or is away from the I/O dock 130 (as shown in FIG. 1B). Both the hard disc array 150 and the motherboard module array 160 are disposed in the chassis 140. When the chassis 140 comes into contact with the I/O dock 130 as shown in FIG. 1A and FIG. 2, the hard disc array 150 and the motherboard module array 160 can receive external power or perform data transmission through the I/O dock 130.

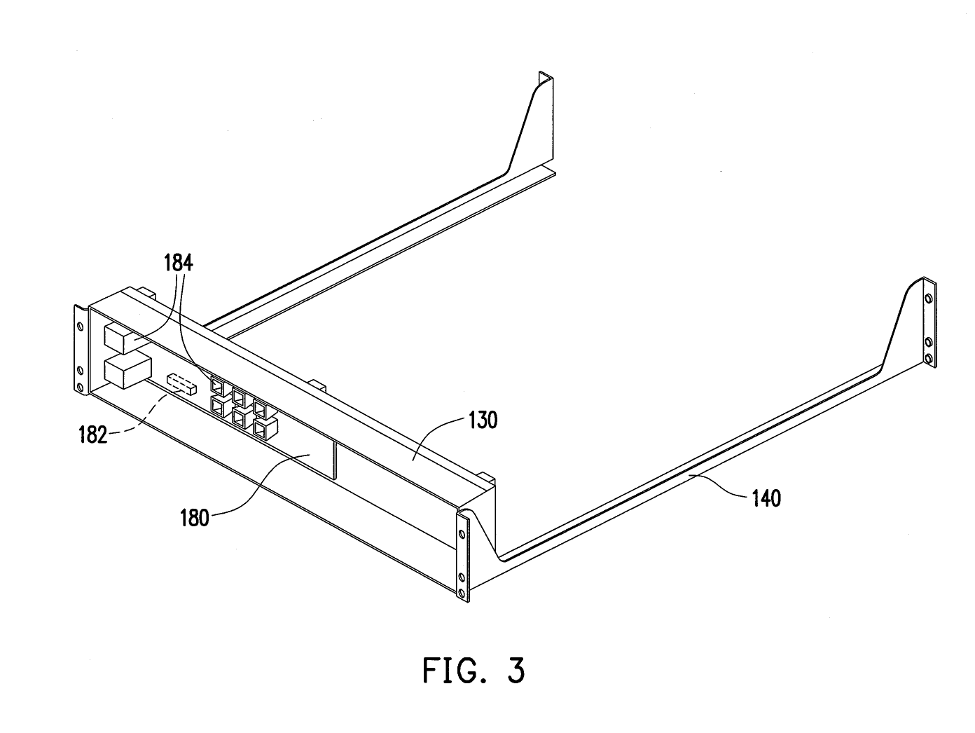

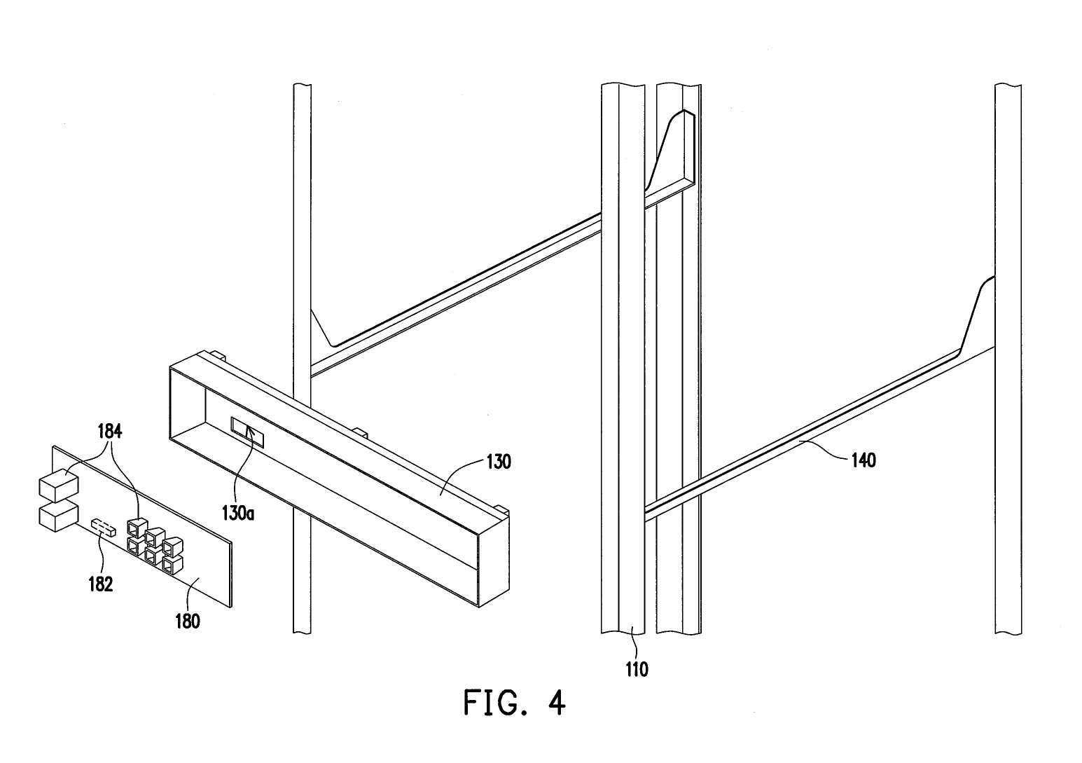

FIG. 3 is a three-dimensional view illustrating some components in the server depicted in FIG. 1A. FIG. 4 is an exploded view illustrating some components in the server depicted in FIG. 1A. As indicated in FIG. 2 to FIG. 4, particularly, the I/O dock 130 has an opening 130a, a connector 146 is disposed at the rear end of the chassis 140, and the connector 146 is electrically connected to the hard disc array 150 and the motherboard module array 160. The server 100 further includes a circuit board 180 disposed on the I/O dock 130. A connector 182 is disposed on one surface of the circuit board 180 facing the chassis 140. The opening 130a exposes the connector 182. A plurality of I/O ports 184 are fixed on the other surface of the circuit board 180 back towards the chassis 140. The I/O ports 184 are electrically connected to the connector 182.

When the chassis 140 comes into contact with the I/O dock 130, the connector 146 connects the connector 182, so as to electrically connect the hard disc array 150 and the motherboard module array 160 to the I/O ports 184. The I/O ports 184 are suitable for being connected to the external power through a cable 50 (shown in FIG. 2) and connected to external devices through cables 60 for data transmission.

According to the aforesaid configuration, during necessary maintenance or repair of the hard click array 150 or the motherboard module array 160 in the chassis 140, the cables 50 and 60 connected to the circuit board 180 need not to be removed, and the chassis 140 can be directly pulled out from the rack 110, which facilitates maintenance and repair of the server 100.

To be more specific, the server 100 of this embodiment further includes cushion elements 170. In the drawings, three cushion elements 170 are exemplarily shown. The cushion elements 170, for example, are made of rubber and disposed on the surface of the I/O dock 130 facing the chassis 140, so as to cushion the impact between the chassis 140 and the I/O dock 130. Thereby, structural damages can be prevented when the chassis 140 is pushed toward the I/O dock 130.

In more detail, as shown in FIG. 1B, there is at least one handle 142 distance between an end of the chassis 140 and the I/O dock 130. Note that two handles 142 are exemplarily illustrated in the drawings. The chassis 140 can be pulled out from the rack 110 or pushed into the rack 110 through the handles 142. Besides, the chassis 140 has two side walls 144. Each of the side walls 144 has at least one ventilator 144a. Heat dissipation air flow is suitable for flowing from one of the side walls 144 to the other one of the side walls 144 through the ventilators 144a, which is conducive to heat dissipation of the hard disc array 150 and the motherboard module array 160.

In light of the foregoing, the I/O dock of the invention is fixed to one end of the slide rail, and the chassis is suitable for moving along the slide rail, such that the chassis comes into contact with the I/O dock or is away from the I/O dock. Accordingly, during necessary maintenance or repair of the hard disc array or the motherboard module array in the chassis, the cables connected to the I/O dock need not to be removed, and the chassis can be directly pulled out from the rack, which facilitates maintenance and repair of the server. Moreover, the cushion element can be disposed on the surface of the I/O dock facing the chassis, so as to cushion the impact between the chassis and the I/O dock. Thereby, structural damages can be prevented when the chassis is pushed toward the I/O dock.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A server comprising:
a rack having a front end and a rear end;
a slide rail disposed in the rack;
an input/output dock located at the rear end of the rack and fixed to an end of the slide rail; and
a chassis slidably disposed on the slide rail, wherein the chassis moves relatively to the rack along the slide rail to come into contact with the input/output dock or to be away from the input/output dock.

2. The server as claimed in claim 1, wherein the input/output dock has an opening, a first connector is disposed at a rear end of the chassis, and the server further comprises:
a circuit board disposed on the input/output dock, wherein a second connector is disposed on one surface of the circuit board facing the chassis, the opening exposes the second connector, a plurality of input/output ports are fixed on the other surface of the circuit board back towards the chassis, and the input/output ports are electrically connected to the second connector;
a hard disc array disposed in the chassis and electrically connected to the first connector; and
a motherboard module array disposed in the chassis and electrically connected to the first connector, wherein when the chassis comes into contact with the input/output dock, the first connector connects the second connector, so as to electrically connect the hard disc array and the motherboard module array to the input/output ports.

3. The server as claimed in claim 1 further comprising a cushion element disposed on a surface of the input/output dock facing the chassis.

4. The server as claimed in claim 1, wherein a material of the cushion element is rubber.

5. The server as claimed in claim 1, wherein there is at least one handle distance between an end of the chassis and the input/output dock.

6. The server as claimed in claim 1, wherein the front end and the rear end of the rack are opposite to each other, the input/output dock is located at the rear end of the rack, and the chassis is suitable for being pulled out from the front end of the rack.

7. The server as claimed in claim 1, wherein the chassis has two side walls, each of the side walls has at least one ventilator, and heat dissipation air flow is suitable for flowing from one of the side walls to the other one of the side walls through the ventilators.
